(19) United States
(12) Patent Application Publication
(10) Pub. No.: US 2008/0198809 A1
(43) Pub. Date: Aug. 21, 2008

(54) Mobile network and handover method thereof

(76) Inventor: Kil-Lyeon Kim, Suwon-si (KR)

Correspondence Address: ROBERT E. BUSHNELL, 1522 K STREET NW, SUITE 300, WASHINGTON, DC, 20005-1202, US

(21) Appl. No.: 12/071,533

(22) Filed: Feb. 21, 2008

(30) Foreign Application Priority Data
Feb. 21, 2007 (KR) 10-2007-0017592

(51) Int. Cl. H04Q 7/20

(52) U.S. Cl. 370/331

(57) ABSTRACT

In a mobile network and a handover method of the mobile network, the uniqueness of an Mobile Station (MS) Medium Access Control (MAC) address is verified when the MS initially enters the mobile network, so that a Duplicate Address Detection (DAD) process may be skipped when the MS hands over to another subnet in the network, thereby shortening an MS handover latency in the mobile network.

### CLAIM OF PRIORITY

This application makes reference to, incorporates the same herein, and claims all benefits accruing under 35 U.S.C. §119 from an application for MOBILE NETWORK AND HANDOVER METHOD THEREOF earlier filed in the Korean Intellectual Property Office on 21 Feb. 2007 and there duly assigned Serial No. 2007-0017592.

### BACKGROUND OF THE INVENTION

1. Field of the Invention

The present invention relates to a mobile network and a handover method thereof, and more particularly, to a mobile network and a handover method thereof in which the uniqueness of a Mobile Station (MS) Medium Access Control (MAC) address is verified when an MS initially enters the mobile network to prevent an MS handover latency.

2. Description of the Related Art

Recently, in response to increase users' demands for advanced multimedia services, more broadband radio access networks are under construction. Of these broadband radio access networks, a mobile World Interoperability for Microwave Access (WiMAX) network provides a broadband radio access of tens of Mb/s to a user who is moving from a location to another location, so that the user may enjoy large capacity and high speed services such as Internet data, voice data and image data. The mobile WiMAX network generally includes a Radio Access Station (RAS) functioning as a Base Station (BS) and an Access Control Router (ACR) functioning as a Base Station Controller (BSC). In the mobile WiMAX network, users may remain connected to the service through handovers between a plurality of RASs.

In a contemporary process in which a Mobile Station (MS) initially enters a mobile WiMAX network, an MS performs a Basic Capability (BC) negotiation. In the BC negotiation, the MS transmits a Subscriber Station Basic Capability Request (SBC-REQ) message to a Radio Access Station (RAS), and the RAS sends the SBC-REQ message in a NetEntryMS State Change Request message to an ACR, thereby requesting an authorization policy therefrom. The ACR sends the authorization policy on a NetEntry MS State Change Response message to the RAS. The RAS sends the authorization policy, received from the ACR, in a Subscriber Station Basic Capability Response (SBC-RSP) message to the MS. The authorization policy includes an authentication method that the MS is supposed to perform, and above stated steps correspond to security negotiation. Thereafter, Privacy Key Management (PKM) authentication is performed.

The ACR transmits an AuthRelay-EAP-Transfer message to the RAS according to an authentication relay protocol, in which the AuthRelay-EAP-Transfer message includes an Extensible Authentication Protocol (EAP) request code and an identifier (ID) of the AuthRelay-EAP-Transfer message. The RAS transmits a PKM-RSP message, including the EAP request code and the ID of the AuthRelay-EAP-Transfer message, to the MS. The MS transmits an EAP Response/Identity-Network Access Identifier (NAI) on the RPK-REQ message to the RAS. The RAS transmits the EAP Response/Identity-NAI on the AuthRelay-EAP-Transfer message to the ACR. The ACR transmits the Response/Identity-NAI of the MS on a DER/EAP over RADIUS message to an Authentication/Authorization/Accounting (AAA) server. The AAA server performs an EAP authentication using the Response/Identity-NAI of the MS, and if the EAP authentication is successful, transmits the result of the EAP authentication on a DEA/EAP over RADIUS message to the ACR. The ACR transmits the successful result of the EAP authentication on a Context-Report message to the RAS. The RAS transmits the successful result of the EAP authentication on the PKM-RSP message to the MS, and transmits a Context-Request-Ack message in response to the Context-Report message to the ACR. Then the MS and the RAS perform 3-way handshaking as defined in PKIM version 2.

After the 3-way handshaking in step S14, the MS transmits a PKM-REQ message to the RAS to request a Traffic Encryption Key (TEK).

In response to the PKM-REQ message, the RAS transmits the TEK on the PKM-RSP message to the MS.

Thereafter, the MS performs IPv6 address configuration via L3 Duplicate Address Detection (DAD).

When a Router Advertisement message is received from the ACR, the MS transmits a Neighbor Solicitation message for the DAD to the RAS, and stands by to receive a response for a predetermined time (e.g., 1 sec). During the DAD process as stated above, the MS cannot perform data communication.

Likewise, at the migration of the MS to the new subnet, if the Care of Address (CoA) of the MS is obtained via the stateless auto-configuration, the DAD process causes a time delay longer than a preset time of the entire L3 handover latency (e.g., 1 sec). The DAD process is performed to verify whether or not the IPv6 address, which the MS attempts to use, is being used by another node. If the IPv6 address is being used by another node, the MS should configure another IPv6. In this case, if the IPv6, which the MS will use in the subnet, is set via the stateless auto-configuration, the proprietary address of the MS, i.e., the MS MAC address is used. This is because, when the MS MAC address is unique, a corresponding IPv6 address is also unique correspondingly. Therefore, when the MS MAC address is proved unique, if the IPv6 address is obtained via the stateless auto-configuration using the MS MAC address, the IPv6 address may be identified as unique in the subnet without the DAD process performed on the IPv6 address.

There are three L3 handover latency factors.

First one is movement Detection which represents a process in which the MS, after migrated to a new subnet, detects its own migration via prefix information of a Router Advertisement (RA) message and a Neighbor Unreachable Detection (NUD) mechanism. The MS may request the RA message using a Router Solicitation (RS) message when necessary.

Second one is DAD which represents a process in which the MS, after having detected its migration, acquires CoA via auto-configuration, and verifies whether or not the acquired CoA is unique. That is, the MS sends the NS message in order to verify whether or not the acquired CoA is being used by another node in the same link, and if the NA message in response to the NS message is not received for a predetermined time period, uses the acquired CoA.

Third one is Binding Update which is a process in which the MS reports the acquired CoA on a Binding Update (BU) message to a Home Agent (HA) and a Correspondent Node (CN). The HA transmits a Binding Acknowledgment message in response to the BU message, thereby maintaining binding information.

Therefore, after the MS enters a Core Service Network (CSN), the MS performs the DAD process for the CoA with the ACR of the subnet.

When the MS migrates to another subnet, the MS acquires a CoA from a new subnet, and performs a DAD process with an ACR of the new subnet.

Accordingly, when the MS performs a handover in the CSN, data communication is disabled whenever the MS performs the DAD process in order to verify the uniqueness of CoA to be used in a migrating subnet.

### SUMMARY OF THE INVENTION

It is therefore an object of the present invention to provide an improved mobile network and a handover method therefor.

It is another object of the present invention to provide a mobile network and a handover method therefor, in which the uniqueness of an MS MAC address is verified when an MS initially enters the mobile network, so that a DAD process can be skipped when the MS hands over to another subnet in the mobile network, thereby preventing MS handover latency.

According to an aspect of the present invention, the mobile network includes an MS transmitting proprietary address information thereof on an authentication request message to the mobile network when entering the mobile network, and controlling verification of an address, which will be used in a new subnet of the mobile network at an event of migration to the new subnet, based on uniqueness of the proprietary address information included in an authentication response message from the mobile network; and an authentication server verifyng whether or not the proprietary address information of the MS is unique in the mobile network, and transmitting verification result information on the authentication response message to the mobile network.

The proprietary address information of the MS may be a Medium Access Control (MAC) address.

The MS may not verify the proprietary address, which will be used in the new subnet of the mobile network at an event of migration to the new subnet, if uniqueness information of the proprietary address information is included in the authentication response message.

The MS may verify the proprietary address, which will be used in the new subnet of the mobile network at an event of migration to the new subnet, if existence information of the proprietary address information is included in the authentication response message.

The authentication server may have a table including proprietary address information used in the mobile network, the table including a proprietary address field, a network access ID field of an MS user and a timeout timer field.

If the proprietary address information in the authentication request message is not included in the table, the authentication server may add the proprietary address information to the table, and transmit uniqueness information of the proprietary address information on the authentication response message to the mobile network.

If the proprietary address information in the authentication request message is included in the table and a network access ID in the authentication request message is identical with a network access ID in the table, the authentication server may update a timeout timer, and transmit the uniqueness information of the proprietary address information on the authentication response message to the mobile network.

If the proprietary address information in the authentication request message is included in the table and the network access ID in the authentication request message is not identical with the network access ID in the table, the authentication server may transmit existence information of the proprietary address information on the authentication response message to the mobile network.

According to another aspect of the present invention, the handover method of a mobile network includes procedures of transmitting proprietary, at an MS, address information thereof on an authentication request message to the mobile network when entering the mobile network; verifying, at the authentication server, whether or not the proprietary address information of the MS in the authentication request message is unique in the mobile network, and transmitting verification result information on an authentication response message to the mobile network; and controlling, at the MS, verification of an address, which will be used in a new subnet of the mobile network at an event of migration to the new subnet, based on uniqueness of the proprietary address information included in the authentication response message from the mobile network.

In the procedure of controlling verification of an address, which will be used in a new subnet of the mobile network at an event of migration to the new subnet, based on uniqueness of the proprietary address information included in the authentication response message from the mobile network, if uniqueness information of the proprietary address information is included in the authentication response message, the MS may set a configuration not to perform the verification of the address, which will be used in the new subnet of the mobile network at an event of migration to the new subnet.

In the procedure of controlling verification of an address, which will be used in a new subnet of the mobile network at an event of migration to the new subnet, based on uniqueness of the proprietary address information included in the authentication response message from the mobile network, if existence information of the proprietary address information is included in the authentication response message, the MS may set a configuration to perform the verification of the address, which will be used in the new subnet of the mobile network at an event of migration to the new subnet.

In the procedure of verifyng whether or not the proprietary address information of the MS in the authentication request message is unique in the mobile network, and transmitting verification result information on an authentication response message to the mobile network, if the proprietary address information in the authentication request message is not included in the table, the authentication server may add the proprietary address information to the table, and transmit uniqueness information of the proprietary address information on the authentication response message to the mobile network.

In the procedure of verifying whether or not the proprietary address information of the MS in the authentication request message is unique in the mobile network, and transmitting verification result information on an authentication response message to the mobile network, if the proprietary address information in the authentication request message is included in the table and a network access ID in the authentication request message is identical with a network access ID in the table, the authentication server may update a timeout timer, and transmit the uniqueness information of the proprietary address information on the authentication response message to the mobile network.

In the procedure of verifying whether or not the proprietary address information of the MS in the authentication request message is unique in the mobile network, and transmitting verification result information on an authentication response message to the mobile network, if the proprietary address information in the authentication request message is included in the table and the network access ID in the authentication request message is not identical with the network access ID in the table, the authentication server may transmit existence information of the proprietary address information on the authentication response message to the mobile network.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a flow diagram illustrating a contemporary process in which an Mobile Station (MS) initially enters a mobile World Interoperability for Microwave Access (WiMAX) network;

FIG. 2 is a diagram illustrating L3 handover latency factors shown as a function of time in the contemporary process, in which an MS initially enters a mobile WiMAX network as shown in FIG. 1;

FIG. 3 is a flow diagram illustrating a process in which an MS initially enters a mobile WiMAX network constructed according to an embodiment of the present invention;

FIG. 4 is a flowchart illustrating MS authentication in an authentication server constructed another embodiment of according to the present invention;

FIG. 5 is a flowchart illustrating a process of verifying the uniqueness of a Medium Access Control (MAC) address of an MS in an Authentication/Authorization/Accounting (AAA) server constructed according another embodiment to the present invention;

FIG. 6 is an MAC address table constructed according to another embodiment the present invention;

FIG. 7 is a flowchart illustrating a process of Duplicate Address Detection (DAD) disabling process of an MS constructed according to another embodiment the present invention; and

FIG. 8 is a diagram illustrating L3 handover latency factors as a function of time in the contemporary process, constructed according to another embodiment the present invention.

### DETAILED DESCRIPTION OF THE INVENTION

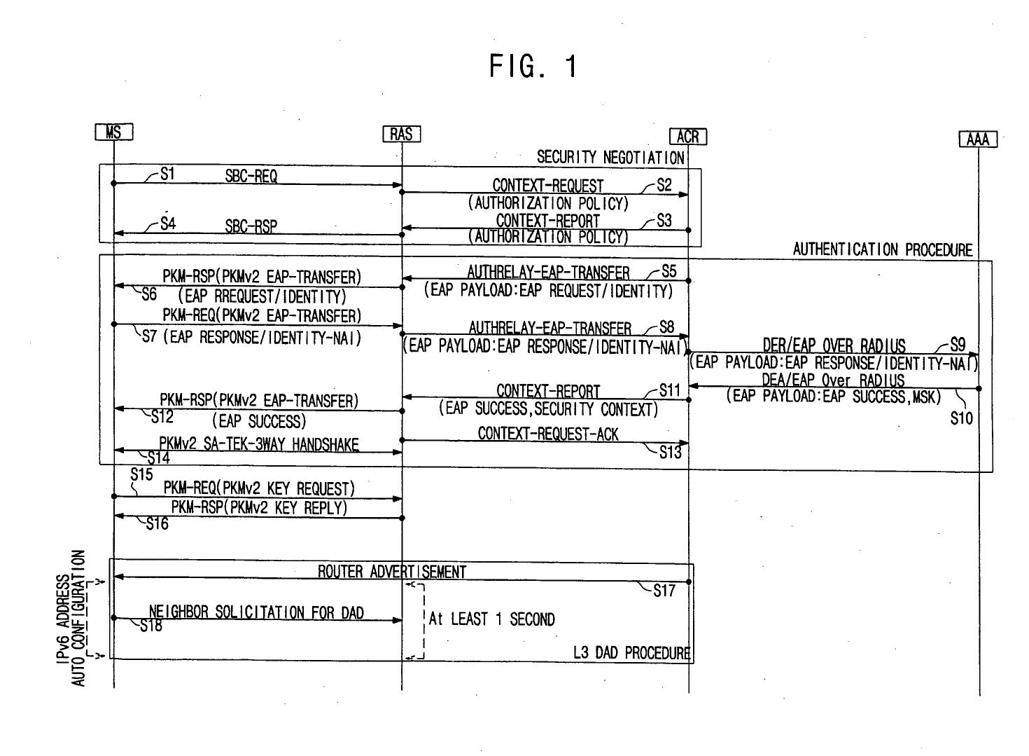

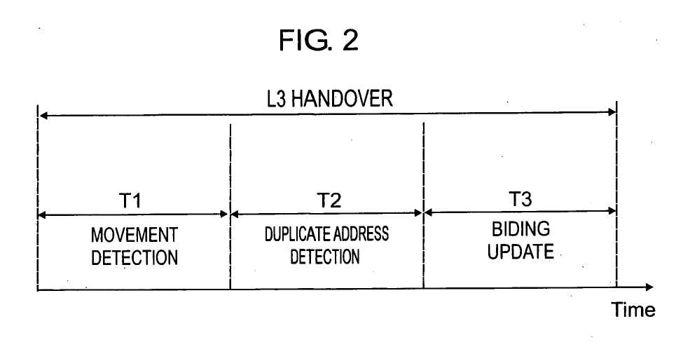

Turning now to FIGS. 1 and 2, a contemporary process in a Mobile Station (MS) initially enters a mobile WiMAX network will be described in details.

A contemporary process in which a Mobile Station (MS) initially enters a mobile WiMAX network is illustrated in FIG. 1.

As shown in FIG. 1, when a MS enters the mobile WiMAX network, an authentication process is performed, which will be described in more detail.

First, a MS performs a Basic Capability (BC) negotiation. In the BC negotiation, the MS transmits a Subscriber Station Basic Capability Request (SBC-REQ) message to a Radio Access Station (RAS) in step S1, and the RAS sends the SBC-REQ message in a NetEntry MS State Change Request message to an ACR, thereby requesting an authorization policy therefrom in step S2.

The ACR sends the authorization policy on a NetEntry MS State Change Response message to the RAS in step S3. The RAS sends the authorization policy, received from the ACR, in a Subscriber Station Basic Capability Response (SBC-RSP) message to the MS in step S4. The authorization policy includes an authentication method that the MS is supposed to perform, and steps S1 through S4 correspond to security negotiation. Thereafter, Privacy Key Management (PKM) authentication is performed.

In step S5, the ACR transmits an AuthRelay-EAP-Transfer message to the RAS according to an authentication relay protocol, in which the AuthRelay-EAP-Transfer message includes an Extensible Authentication Protocol (EAP) request code and an identifier (ID) of the AuthRelay-EAP-Transfer message. The RAS transmits a PKM-RSP message, including the EAP request code and the ID of the AuthRelay-EAP-Transfer message, to the MS in step S6. The MS transmits an EAP Response/Identity-Network Access Identifier (NAI) on the RPK-REQ message to the RAS in step S7. The RAS transmits the EAP Response/Identity-NAI on the AuthRelay-EAP-Transfer message to the ACR in step S8. The ACR transmits the Response/Identity-NAI of the MS on a DER/EAP over RADIUS message to an Authentication/Authorization/Accounting (AAA) server in step S9. The AAA server performs an EAP authentication using the Response/Identity-NAI of the MS, and if the EAP authentication is successful, transmits the result of the EAP authentication on a DEA/EAP over RADIUS message to the ACR in step S10. The ACR transmits the successful result of the EAP authentication on a Context-Report message to the RAS in step S11. The RAS transmits the successful result of the EAP authentication on the PKM-RSP message to the MS in step S12, and transmits a Context-Request-Ack message in response to the Context-Report message to the ACR in step S13. Next, in step S14, the MS and the RAS perform 3-way handshaking as defined in PKIM version 2.

After the 3-way handshaking in step S14, the MS transmits a PKM-REQ message to the RAS to request a Traffic Encryption Key (TEK) in step S15.

In response to the PKM-REQ message, the RAS transmits the TEK on the PKM-RSP message to the MS in step S16.

Thereafter, the MS performs IPv6 address configuration via L3 Duplicate Address Detection (DAD) in steps S17 and S18.

The DAD is a process performed, when the MS (host) sets an IPv6 address in a specific interface, in order to verify whether or not the IPv6 address configured in a link, which the MS is connected to, is unique.

The DAD process involves exchanging a Neighbor Solicitation (NS) message and a Neighbor Advertisement (NA) message. The MS essentially performs the DAD process before usage by setting a specific unicast IPv6 address in the interface, with the unicast IPv6 address acquired via either manual configuration, or stateful auto-configuration, or stateless auto-configuration.

In other words, as shown in FIG. 1, when a Router Advertisement message is received from the ACR instep S17, the MS transmits a Neighbor Solicitation message for the DAD to the RAS in step S18, and stands by to receive a response for a predetermined time (e.g., 1 sec). During the DAD process as stated above, the MS cannot perform data communication.

Likewise, at the migration of the MS to the new subnet, if the Care of Address (CoA) of the MS is obtained via the stateless auto-configuration, the DAD process causes a time delay longer than a preset time of the entire L3 handover latency (e.g., 1 sec). The DAD process is performed to verify whether or not the IPv6 address, which the MS attempts to use, is being used by another node. If the IPv6 address is being used by another node, the MS should configure another IPv6. In this case, if the IPv6, which the MS will use in the subnet, is set via the stateless auto-configuration, the proprietary address of the MS, i.e., the MS MAC address is used. This is because, when the MS MAC address is unique, a corresponding IPv6 address is also unique correspondingly. Therefore, when the MS MAC address is proved unique, if the IPv6 address is obtained via the stateless auto-configuration using the MS MAC address, the IPv6 address may be identified as unique in the subnet without the DAD process performed on the IPv6 address.

Three L3 handover latency factors (i.e. T1, T2 and T3) of the MS are shown in FIG. 2 as a function of time. As shown in FIG. 2, Movement Detection (T1) represents a process in which the MS, after migrated to a new subnet, detects its own migration via prefix information of a Router Advertisement (RA) message and a Neighbor Unreachable Detection (NUD) mechanism. The MS may request the RA message using a Router Solicitation (RS) message when necessary.

DAD (T2) represents a process in which the MS, after having detected its migration, acquires CoA via auto-configuration, and verifies whether or not the acquired CoA is unique. That is, the MS sends the NS message in order to verify whether or not the acquired CoA is being used by another node in the same link, and if the NA message in response to the NS message is not received for a predetermined time period, uses the acquired CoA.

If the NA message is received, however, the MS cannot allocate the CoA to the network interface. Binding Update (T3) is a process in which the MS reports the acquired CoA on a Binding Update (BU) message to a Home Agent (HA) and a Correspondent Node (CN). The HA transmits a Binding Acknowledgment message in response to the BU message, thereby maintaining binding information.

As discussed above with reference to FIGS. 1 and 2, after the MS enters a Core Service Network (CSN), the MS performs the DAD process for the CoA with the ACR of the subnet.

Next, when the MS migrates to another subnet, the MS acquires a CoA from a new subnet, and performs a DAD process with an ACR of the new subnet.

Accordingly, when the MS performs a handover in the CSN, data communication is disabled whenever the MS performs the DAD process in order to verify the uniqueness of CoA to be used in a migrating subnet.

The present invention will now be described more fully hereinafter with reference to the accompanying drawings, in which a mobile network and a handover method thereof according to the present invention are shown.

Reference now should be made to the drawings, in which the same reference numerals and signs are used throughout the different drawings to designate the same or similar components.

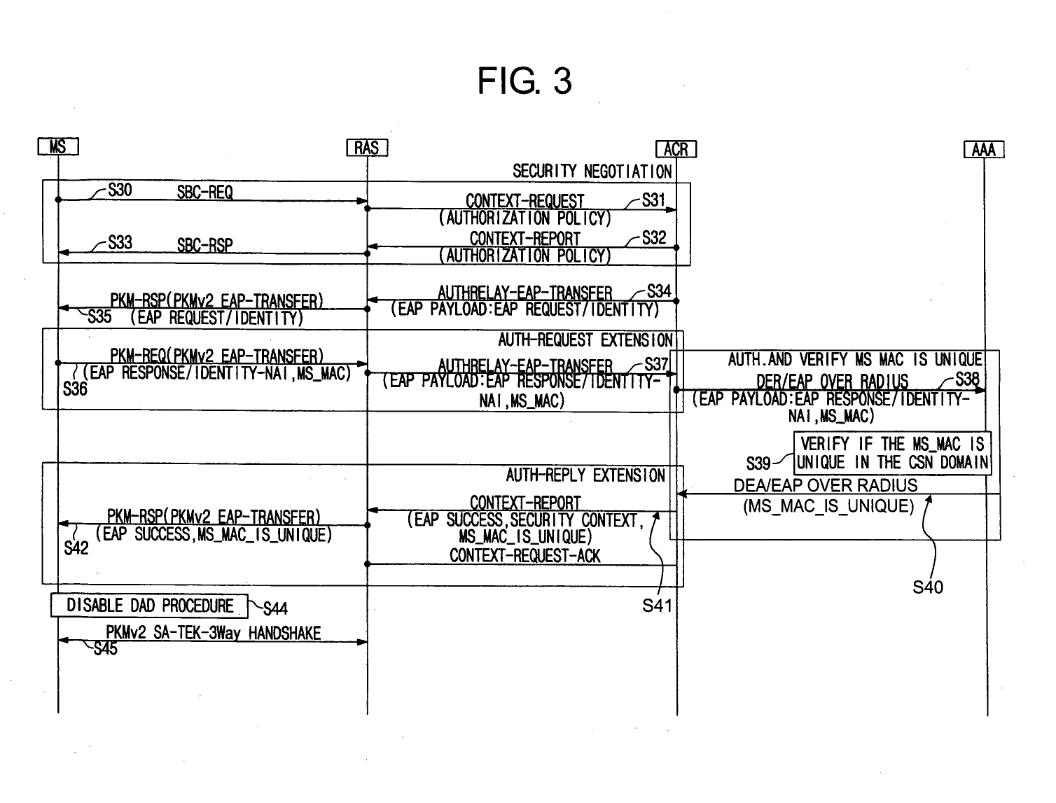

FIG. 3 is a flow diagram illustrating a process in which an MS initially enters a mobile WiMAX network constructed according to the present invention.

As shown in FIG. 3, first, the MS performs Basic Capability (BC) negotiation. In the BC negotiation, the MS transmits an SBC-REQ message to an RAS in step S30, and the RAS sends the SBC-REQ message on a Net Entry MS State Change Request message to an ACR, thereby requesting an authorization policy therefrom in step S31.

The ACR sends the authorization policy on a NetEntry MS State Change Response message to the RAS in step S32.

The RAS sends the authorization policy, received from the ACR, on an SBC-RSP message to the MS in step S33. The authorization policy includes an authentication method that the MS is supposed to perform, and the above steps S30 to S33 correspond to security negotiation. Thereafter, Privacy Key Management (PKM) authentication is performed.

In step S34, the ACR transmits an AuthRelay-EAP-Transfer message to the RAS according to an authentication relay protocol, in which the AuthRelay-EAP-Transfer message includes an EAP request code and an ID of the AuthRelay-EAP-Transfer message.

The RAS transmits a PKM-RSP message, including the EAP request code and the ID of the AuthRelay-EAP-Transfer message, to the MS in step S35.

The MS transmits an EAP Response/Identity-NAI and an MS MAC address on the RPK-REQ message to the RAS in step S36. The RAS transmits the EAP Response/Identity-NAI on the AuthRelay-EAP-Transfer message to the ACR in step S37.

The ACR transmits the Response/Identity-NAI of the MS on a DER/EAP over RADIUS Auth Request message to an AAA server in step S38.

The AAA server performs an EAP authentication using the Response/Identity-NAI of the MS, and if the EAP authentication is successful, verifies whether or not the MS MAC address is unique in a mobile CSN in step S39.

If the MS MAC address is unique in the mobile CSN, the AAA server transmits MS MAC address uniqueness information (MS_MAC_IS_UNIQUE) on a DEA/EAP over RADIUS message to the ACR in step S40.

The ACR transmits the MS MAC address uniqueness information (MS_MAC_IS_UNIQUE) on a Context-Report message to the RAS in step S41.

The RAS transmits the MS MAC address uniqueness information (MS_MAC_IS_UNIQUE) on the PKM-RSP message to the MS in step S42, and transmits a Context-Request-Ack message in response to the Context-Report message to the ACR in step S43.

Based on the MS MAC address uniqueness information included in the PKM-RSP message from the RAS, the MS disables a DAD function in step S44.

In other words, the MS skips a DAD process of verifying CoA uniqueness when it performs a handover to another subnet in the mobile CSN.

Thereafter, in step S45, the MS and the RAS perform 3-way handshaking as defined in PKIM version 2.

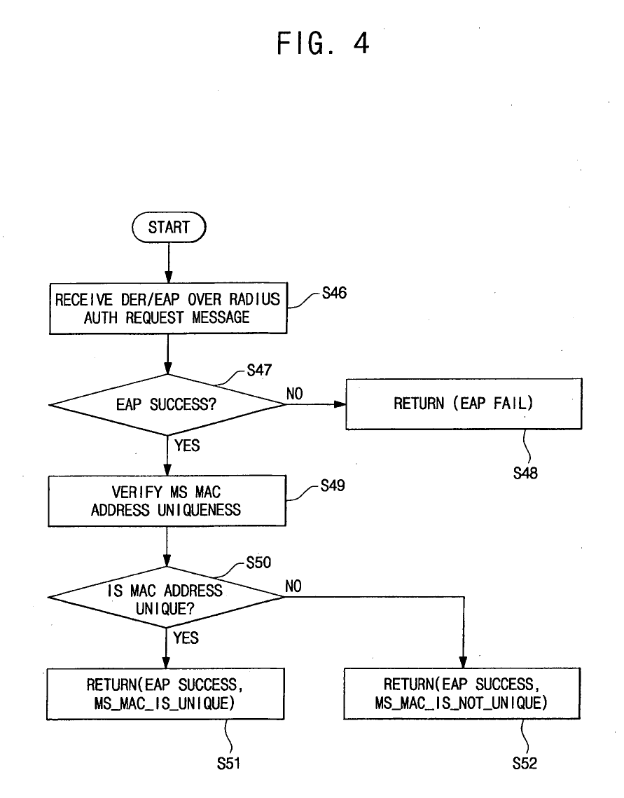

FIG. 4 is a flowchart illustrating MS authentication in an authentication server constructed according to the present invention.

As shown in FIG. 4, in step S46, the AAA server authenticates the MS when the DRE/EAP over RADIUS Auth Request message is received from the RAS.

The AAA server verifies whether or not the authentication of the MS is successful in step S47, if the authentication is failed, transmits an EAP Fail message to the ACR in step S48.

If the authentication of the MS is successful, the AAA server verifies whether or not the MS MAC address is unique in the mobile CSN in step S49 and step S50. Here, the AAA server is required to store a plurality of MAC addresses that are being used in the mobile CSN.

If the MS MAC address is unique in the mobile CSN, the AAA server transmits the MS MAC address uniqueness information (MS_MAC_IS_UNIQUE) on the DEA/EAP over RADIUS message to the ACR in step S51.

If the MS MAC address is not unique in the mobile CSN, that is, the MS MAC address already exists, the AAA server transmits MS MAC address existence information (MS_MAC_IS_NOT_UNIQUE) (i.e., information representing that the MS MAC address exists) on the DEA/EAP over RADIUS message to the ACR in step S52.

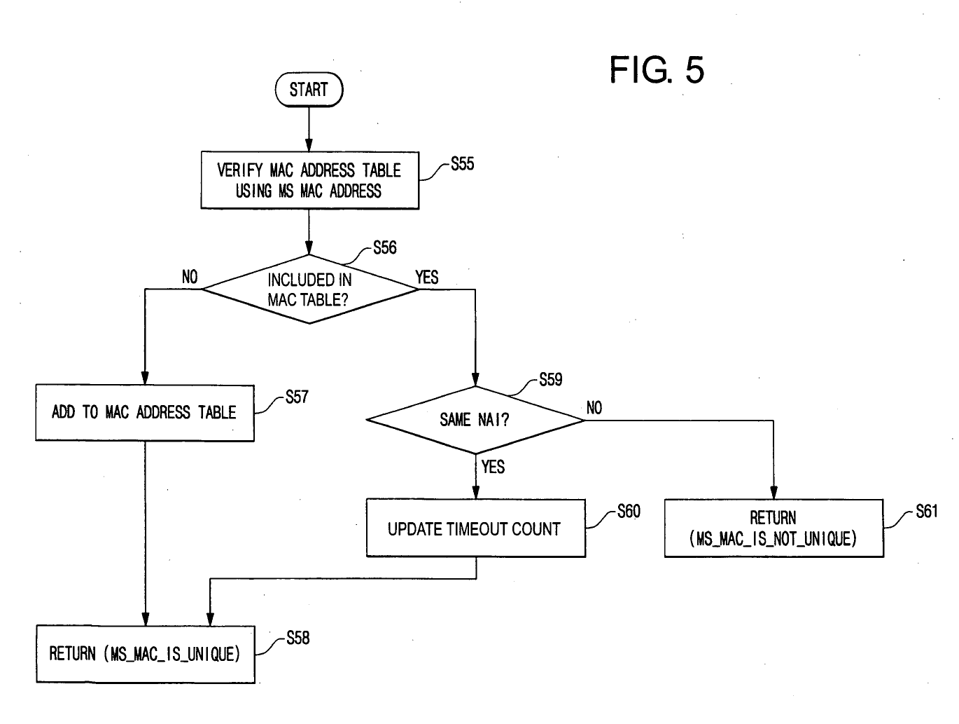

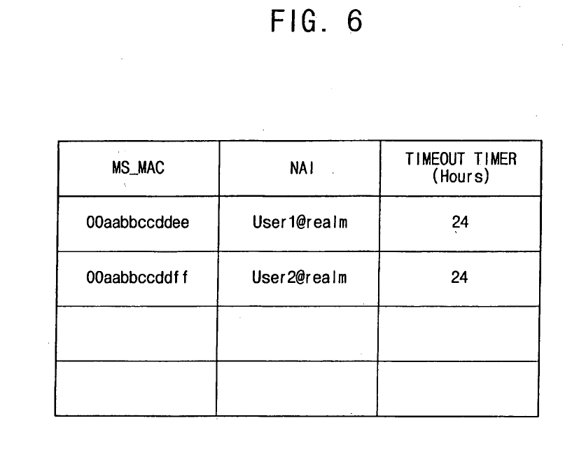

Turning now to FIGS. 5 and 6, FIG. 5 is a flowchart illustrating a process of verifying the uniqueness of the MAC address of an MS in an AAA server constructed according to the present invention, and FIG. 6 is an MAC address table constructed according to another embodiment the present invention.

As shown in FIG. 5, the AAA server examines a MAC address table including MAC addresses, which are being used in the mobile CSN, based on the MS MAC address in step S55. This MAC address table is shown in FIG. 6.

As shown in FIG. 6, the MAC address table includes MAC address fields (MS_MAC) representing MS MAC addresses used in the mobile CSN, NAI fields representing network access IDs of MS users having an MAC address and timeout timer fields representing timeout timers for the MAC addresses.

In step S56, the AAA server verifies whether or not the MS MAC address is included in the MAC address table as shown in FIG. 6.

If the MS MAC address is included in the MAC address table, the AAA server verifies whether or not the network access ID (NAI) of the MS MAC address is the same as the network ID of the MAC address table in step S59.

If the network access ID of the MS MAC address is the same as the network ID of the MAC address table, the AAA updates the timeout timer of the MAC address table in step S60, and transmits the MS MAC address uniqueness information (MS_MAC_IS_UNIQUE) on the DEA/EAP over RADIUS message to the ACR in S58.

If the network access ID of the MS MAC address is not the same as the network ID of the MAC address table, the AAA transmits the MS MAC address existence information (MS_MAC_IS_NOT_UNIQUE) on the DEA/EAP over RADIUS message to the ACR in step S61.

Returning to step S56, if the MS MAC address is not included in the MAC address table, the AAA server adds an entry of the MS MAC address to the MAC address table in step S57.

Thereafter, the AAA server transmits the MS MAC address uniqueness information (MS_MAC_IS_UNIQUE) on the DEA/EAP over RADIUS message to the ACR in step S58.

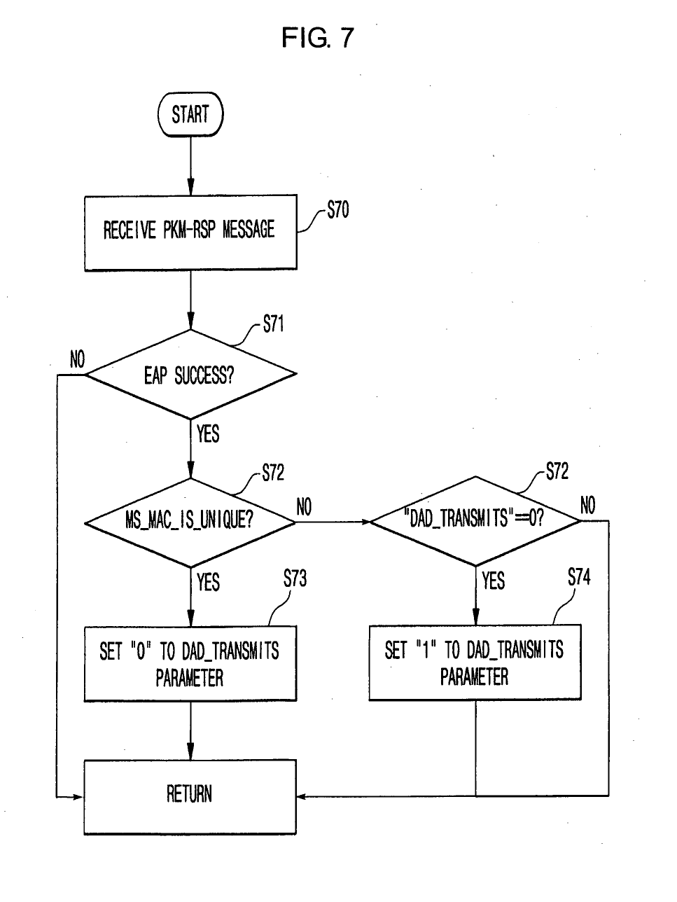

FIG. 7 is a flowchart illustrating a process of disabling the DAD process for an MS constructed according to the present invention.

As shown in FIG. 7, the MS receives the PKM-RSP message in step S70, and verifies whether or not the PKM-RSP message includes EAP success information in step S71.

If the PKM-RSP message includes the EAP success information, the MS verifies whether or not the PKM-RSP message includes the MS MAC address uniqueness information (MS_MAC_IS_UNIQUE) in step S72.

If the MS MAC address uniqueness information (MS_MAC_IS_UNIQUE) is included, the MS sets “0” to a parameter dad_transmits, which represents the activation status of the DAD function in step S74.

In other words, the MS sets “0” to parameter dad_transmits, so that the DAD process of verifying the CoA uniqueness may be skipped in the case where the MS hands over to another subnet.

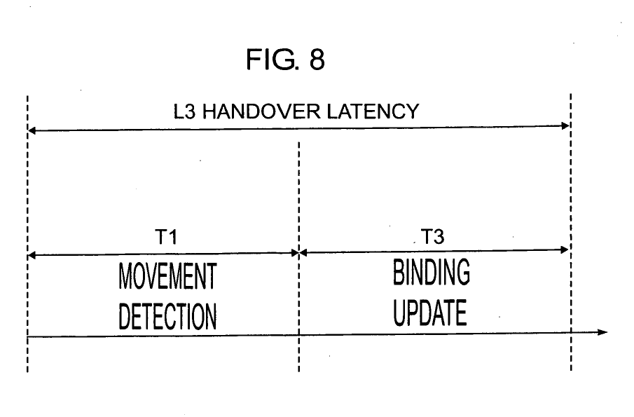

L3 handover latency of this case is shown in FIG. 8 as a function of time.

As shown in FIG. 8, the DAD process of verifying the CoA uniqueness can be skipped when the MS hands over to another subnet.

If the MS MAC address uniqueness information (MS_MAC_IS_UNIQUE) is not included, however, the MS verifies whether or not “1” is set to a dad_transmits parameter, which represents the activation status of the DAD function in step S72.

If the dad_transmits parameter is set “0,” the MS sets the dad_transmits parameter “1” in step S74.

In other words, the MS sets the dad_transmits parameter “1,” so that the DAD process of verifying the CoA uniqueness can be performed when the MS hands over to another subnet.

According to the mobile network and the handover method thereof of the present invention as set forth above, the uniqueness of the MS MAC address is verified when the MS initially enters the network, so that the DAD process may be skipped when the MS hands over to another subnet in the network, thereby preventing MS handover latency. Therefore, the present invention shortens the total MS handover latency time by preventing second latency factor T2 as shown in FIG. 2 under predetermined conditions as stated above.

While the present invention has been shown and described in connection with the preferred embodiments, it will be apparent to those skilled in the art that modifications and variations can be made without departing from the spirit and scope of the present invention as defined by the appended claims.

What is claimed is:

1. A mobile network, comprising:
a mobile station transmitting a proprietary address information of the mobile station carried by transmission of an authentication request message to the mobile network when the mobile station initially enters the mobile network, and controlling verification of an address of the mobile station, which will be used in a new subnet of the mobile network at an event of migration to the new subnet, based on a uniqueness of the proprietary address information included in an authentication request message transmitted from the mobile station; and
an authentication server verifying whether or not the proprietary address information of the mobile station is unique in the mobile network, and transmitting verification result information carried by an authentication response message to the mobile station.

2. The mobile network according to claim 1, with the proprietary address information of the mobile station comprising a medium access control address.

3. The mobile network according to claim 1, in which the mobile station does not verify the address of the mobile station, said address will be used in the new subnet of the mobile network at an event of migration to the new subnet, when uniqueness information of the proprietary address information is included in the authentication response message.

4. The mobile network according to claim 3, comprised of the mobile station verifying the address which will be used in the new subnet of the mobile network at an event of migration to the new subnet, when an existence information of the proprietary address information of the mobile station is included in the authentication response message.

5. The mobile network according to claim 1, comprised of the authentication server having a table including the proprietary address information used in the mobile network, the table comprising a proprietary address field, a network access identifier field of a mobile station user and a timeout timer field.

6. The mobile network according to claim 5, comprised of when the proprietary address information in the authentication request message is not included in the table, the authentication server adding the proprietary address information to the table, and transmitting uniqueness information of the proprietary address information on the authentication response message to the mobile network.

7. The mobile network according to claim 6, when the proprietary address information in the authentication request message is included in the table and a network access identifier in the authentication request message is identical with one of the network access identifiers in the table, the authentication server updates a timeout timer, and transmits the uniqueness information of the proprietary address information on the authentication response message to the mobile network.

8. The mobile network according to claim 7, comprised of, when the proprietary address information in the authentication request message is included in the table and the network access identifier in the authentication request message is not identical with the network access identifier in the table, the authentication server transmits existence information of the proprietary address information on the authentication response message to the mobile network.

9. A handover method of a mobile network, comprising:
at a mobile station, transmitting proprietary address information of the mobile station carried by an authentication request message to the an authentication server when the mobile station entering the mobile network;
at the authentication server, verifying whether or not the proprietary address information of the mobile station in the authentication request message is unique in the mobile network, and transmitting verification result information carried by an authentication response message to the mobile station; and
at the mobile station, controlling verification of an address, which will be used in a new subnet of the mobile network at an event of migration to the new subnet, based on a uniqueness of the proprietary address information included in the authentication response message from the authentication server.

10. The handover method according to claim 9, comprised of the proprietary address information of the mobile station comprising a medium access control address.

11. The handover method according to claim 9, with the procedure of, at the mobile station, controlling verification of an address, which will be used in a new subnet of the mobile network at an event of migration to the new subnet, based on the uniqueness of the proprietary address information included in the authentication response message from the authentication server, further comprising:
when the uniqueness information of the proprietary address information is included in the authentication response message, setting a configuration not to perform the verification of the address, which will be used in the new subnet of the mobile network at an event of migration to the new subnet.

12. The handover method according to claim 11, with the procedure of, at the mobile station, controlling verification of an address, which will be used in a new subnet of the mobile network at an event of migration to the new subnet, based on uniqueness of the proprietary address information included in the authentication response message from the mobile network, further comprising:
when existence information of the proprietary address information is included in the authentication response message, setting a configuration to perform the verification of the address, which will be used in the new subnet of the mobile network at an event of migration to the new subnet.

13. The handover method according to claim 9, with the procedure of, at the authentication server, verifying whether or not the proprietary address information of the mobile station in the authentication request message is unique in the mobile network, and transmitting verification result information on an authentication response message to the mobile network, further comprising:
when the proprietary address information in the authentication request message is not included in the table, adding the proprietary address information to the table, and transmits uniqueness information of the proprietary address information on the authentication response message to the mobile network.

14. The handover method according to claim 13, with the procedure of, at the authentication server, verifying whether or not the proprietary address information of the mobile station in the authentication request message is unique in the mobile network, and transmitting verification result information on an authentication response message to the mobile network, further comprising:
when the proprietary address information in the authentication request message is included in the table and a network access identifier in the authentication request message is identical with a network access identifier in the table, updating a timeout timer, and transmitting the uniqueness information of the proprietary address information on the authentication response message to the mobile network.

15. The handover method according to claim 14, with the procedure of, at the authentication server, verifying whether or not the proprietary address information of the mobile station in the authentication request message is unique in the mobile network, and transmitting verification result information on an authentication response message to the mobile network, further comprising:
when the proprietary address information in the authentication request message is included in the table and the network access identifier in the authentication request message is not identical with the network access identifier in the table, transmitting existence information of the proprietary address information on the authentication response message to the mobile network.

16. A mobile network, comprising:
a mobile station transmitting a proprietary address information of the mobile station carried by an authentication request message to the mobile network when the mobile station initially enters the mobile network, and controlling verification of an address of the mobile station, which will be used in a new subnet of the mobile network at an event of migration to the new subnet, based on a uniqueness of the proprietary address information included in an authentication request message transmitted from the mobile station;
an authentication server verifying whether or not the proprietary address information of the mobile station is unique in the mobile network, and transmitting a verification result information carried by an authentication response message to the mobile station;
the mobile station disabling a Duplicate Address Detection process when the mobile station receives mobile station address uniqueness information determined by the authentication server; and
said mobile station and said authentication server transmitting information comprising a mobile station address uniqueness information and an existence information of the mobile station address information through a radio access station and an access control router installed between said mobile station and said authentication server.

17. A mobile network, comprising:
a radio access station functioning as a Base Station by connecting users through handovers to a mobile network comprising:
a mobile station transmitting a proprietary address information of the mobile station carried by an authentication request message to the mobile network when the mobile station initially enters the mobile network, and controlling verification of an address of the mobile station, which will be used in a new subnet of the mobile network at an event of migration to the new subnet, based on a uniqueness of the proprietary address information included in an authentication request message transmitted from the mobile station, and
an authentication server verifying whether or not the proprietary address information of the mobile station is unique in the mobile network, and transmitting a verification result information carried by an authentication response message to the mobile station;
said radio access station receiving the authorization policy request from said mobile station and transmitting the authorization policy request to an access control router, and receiving a mobile station address uniqueness information determined by an authentication server and transmitting the mobile station address uniqueness information to said mobile station;
said Access Control Router functioning as a Base Station Controller by transmitting an authorization policy to said radio access station upon receiving the authorization policy request from said radio access station, transmitting a first message including Extensible Authentication Protocol request code and an identifier of said message to said mobile station through said radio access station, receiving a second message including the address of said mobile station from said mobile station through said radio access station, and transmitting the second message including the address of said mobile station to the authentication server; and
the mobile station disabling a Duplicate Address Detection process when the mobile station receives mobile station address uniqueness information determined by the authentication server.
